(19) United States
(12) Patent Application Publication
(10) Pub. No.: US 2007/0036994 A1
(43) Pub. Date: Feb. 15, 2007

(54) Multiple zone structure capable of light radiation annealing and method using said structure

(76) Inventors: Bernard Andre, Grenoble (FR); Jean Hue, Meylan (FR); Berangere Hyot, Eybens (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/571,128

(22) PCT Filed: Sep. 14, 2004
(86) PCT No.: PCT/FR04/50430

§ 371 Date: Mar. 9, 2006

(30) Foreign Application Priority Data
Sep. 17, 2003 (FR) 0350562

(51) Int. Cl. B23K 26/00; B32B 15/04

(52) U.S. Cl. 428/457; 219/121.66; 428/702

(57) ABSTRACT

A method for modifying via a heat effect a characteristic of a first zone of a first material, wherein a light radiation is directed towards a second zone in a second material, the diffusion of the heat energy from the second zone to the first zone allowing thermal modification of the first zone.

### TECHNICAL FIELD

The invention relates to annealing techniques by light radiation or irradiation, in particular by a laser, notably of thin layers, but also of massive materials.

Laser-annealing is a known annealing technique for thin layers. This technique utilizes the fact that a thin layer may be optically absorptive at certain wavelengths. By using a laser, the wavelength of which corresponds to the spectral range where the layer absorbs light, there is absorption of photons and heating of the layer to be annealed.

The temperatures may be very high (a few hundreds of degrees to a few thousands of degrees) according to the absorption coefficient of the material and the characteristics of the laser (notably its power, wavelength, repetition rate, pulse width and shape).

This technique is of interest because by the spatial resolution of the lasers, it is possible to achieve localized anneals. For example, with this a zone of the material or a specific thin layer in a stack of thin layers may be specifically annealed; this is not possible with conventional annealing which concerns the material or the structure in its whole.

The absorptive layer(s) of a multilayer structure may be selectively annealed by light irradiation, in particular by a laser, in order to change the physical or chemical characteristics of certain layers directly irradiated by the laser. Heat diffusion outside the annealed layers generally is a drawback which may be contended by heat diffusion barriers or selecting materials which are able not to undergo any adverse change in their own physical or chemical characteristics under the influence of this irradiation.

On the other hand, annealing difficulties occur in certain cases, notably when a layer to be annealed is not very or even not absorptive, or even when there is no laser available having emission lines in the wavelength ranges for which the layer to be annealed is absorptive. Indeed, laser emission wavelengths are discrete and those available to an industrialist do not necessarily cover the spectral range of interest.

Another problem is posed when a zone or a layer, which would be absorptive and for which there may be an available wavelength, would however exhibit poor fastness or insufficient fastness to the light flux.

### SUMMARY OF THE INVENTION

The invention relates to an annealing method or a method for modifying via a heat effect, a characteristic, for example a physical or chemical characteristic, of a first zone in a first material, a method in which a laser beam is directed towards a second zone in a second material, diffusion of heat energy from the second towards the first zone allowing the modification via a heat effect or the annealing of the latter.

Each of the materials may include one or several types of atoms or molecules, and for example may be an alloy or a composite material.

Near or close to or in contact with the zone to be annealed, which for example has the shape of a thin layer, the invention uses another zone, for example it also as a thin layer which absorbs radiation. The absorptive zone will heat up and by heat transfer, will raise the temperature in the zone to be annealed. The rise in temperature may be larger than 100° C. or several hundreds of degrees C., for example larger than 500° C. or 1,000° C.

The second zone for example has larger light irradiation absorption than that of the first zone.

The second material will preferably be selected for its heat diffusion properties: it will be preferable to have a material which may at best transfer the heat generated by the laser and notably towards the first zone.

Both zones may either be in contact with each other or not. For example, they may be formed by two neighboring portions of a same layer, or even by two neighboring areas of massive material.

According to an example, the first material is SrTiO₃ and the second is metal, for example platinum.

The invention also relates to a system of materials or even to a heterogeneous assembly or heterogeneous system of materials including:
a first zone in a first material, having a physical and/or chemical characteristic able to be thermally modified,
a second zone in a second material, in order to absorb at least one portion of laser radiation at a wavelength, and to transfer at least one portion of the heat energy resulting from this absorption to the first zone.

### DETAILED DESCRIPTION OF EMBODIMENTS OF THE INVENTION

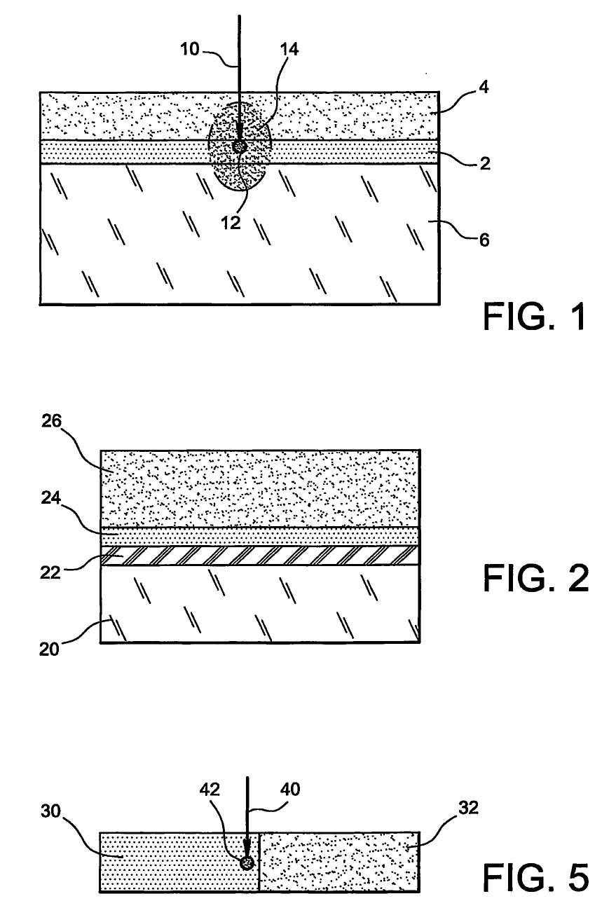

FIG. 1 illustrates a first embodiment of the invention.

A layer 2 allows absorption of a laser beam 10 and heat transfer towards the zones or the neighboring layers, and notably towards a layer 4 to be annealed, or whose characteristic one desires to modify. The assembly also rests on a substrate 6.

A laser beam 10 is directed towards the layer 2 or focused on this layer, reference 12 designating the laser impact, i.e., the zone where the main part of the energy of the laser is absorbed. A zone 14 around the impact 12 is heated by heat diffusion. The heat or thermal energy will therefore partly diffuse from zone 2, towards zone 4 which may receive or is able to receive this heat energy. A physical or chemical or structural characteristic of this zone 4 is thereby modified, at least locally in the zone 4, a modification which persists or which is durable or permanent even after stopping the laser beam.

The physical or chemical characteristics of the material of the zone 4 which one tries to modify with this technique, for example are optical and/or electrical and/or magnetic and/or thermal and/or crystalline or amorphous characteristic(s) and/or its chemical composition (as in the case of diffusion by annealing of dopants).

The laser irradiation time will depend on the desired transformation, on the absorption of layer 2, or its heat diffusion properties (heat conductivity coefficient) towards the layer 4 and on the heat absorption capacities and heating of this layer 4.

In other words, heat transfer towards the zone to be annealed will depend on the attained temperature in the zone which absorbs radiation, and on the heat constants of the latter as well as of the zone to be annealed.

It will be noted that the absorption of a layer is related to the absorption coefficient of the material of this layer and to its thickness.

Irradiation may be performed through a support of said zones, this support being transparent to at least one portion of the light irradiation.

There may also be irradiation of both zones 2 and 4, both zones contributing to absorption of energy.

The thin layer 2 which absorbs the radiation may be produced by any type of deposition, CVD, PVD or sol-gel method, for example.

Another exemplary embodiment will be given which relates to the annealing of a material of the SrTiO₃ type.

These materials are used as strong dielectric permittivity materials. They have high dielectric constants when they are crystallized. Moreover, the constraints imposed by the components into which these materials are integrated, impose a process temperature less than 450° C. Now, these materials are amorphous when they are produced at temperatures typically less than 600° C. Laser annealing, with which the SrTiO₃ layer may be heated to the crystallization temperature, without heating the structures of the complete device, is therefore of interest.

In order to anneal these materials, a laser may be used, based for example on triple YAG.

This type of laser emits at wavelengths close to 350 nm. Unfortunately, a SrTiO₃ layer to be annealed at 350 nm has a very small absorption coefficient and the coupling of the laser pulse energy with this layer is low. Simulations show that a layer with a thickness of 200 nm absorbs 3% of the energy, which does not provide a sufficient temperature rise in the strong permittivity material.

Simulations were carried out for a structure such as the one of FIG. 2 and including a silicon substrate 20, a SiO₂ layer 22, a platinum layer 24 and a layer 26 of material with high dielectric constant K, for example SrTiO₃.

Here, it is platinum 24 which will play the role of an absorptive layer and will transfer to the material 26 a portion of the energy which it has absorbed.

Simulations temperature rises in this structure were performed, in the case of the impact of a 30 ns laser pulse at the wavelength of 350 nm. The fluence selected for the simulations is 300 mJ/cm².

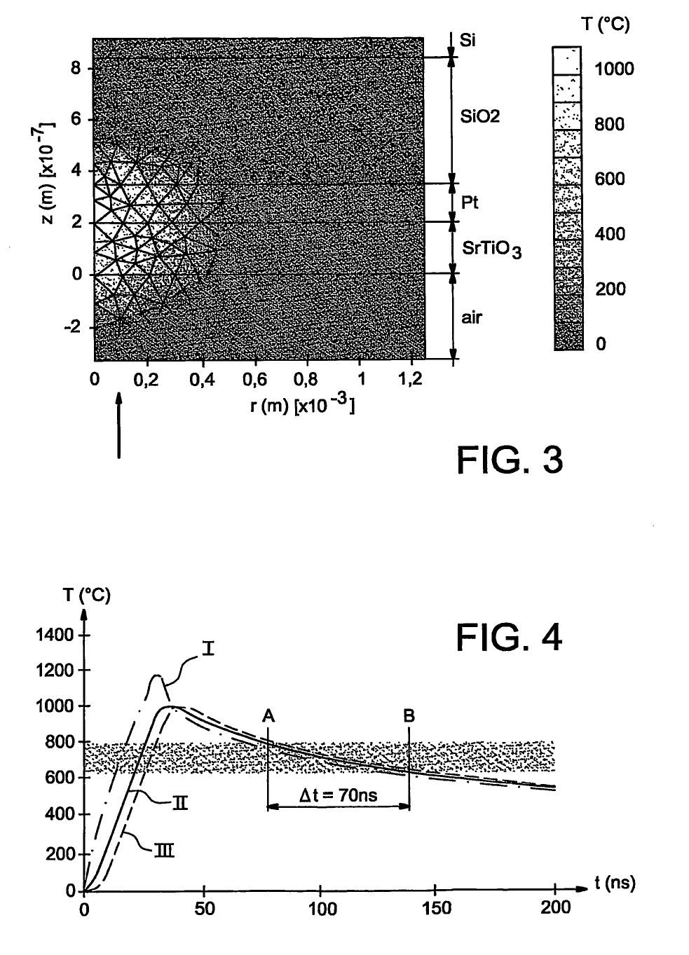

As stated, material 26 is not very absorptive at 350 nm (3% absorption in a 200 nm layer); it is platinum 24 (Pt) which in majority absorbs the optical energy (88% absorption) and which heats by conduction the material which is in contact with it. FIG. 3 illustrates at t=30 ns after the beginning of the pulse, the value of the temperature from the centre of the laser impact (substantially localized at the 2.10⁻⁷ position on the vertical axis “Z”). This figure shows that, under the irradiation conditions (pulse duration of 30 ns), it is possible to achieve over the whole thickness of material 26 temperatures contributing to crystallization of the material, for example between 700 and 800° C.

For a laser pulse of 30 ns duration and a fluence a 300 mJ/cm², FIG. 4 shows heat profiles plotted at different depth levels in layer 26: at the interface layer 26—layer 24 (curve I), in the middle of the layer 26 (curve II) and at the interface layer 26—air (curve III). These profiles confirm the analysis performed above.

Insofar that, for providing effective crystallization of the material, one attempts to spend as much time as possible at the temperature where the crystalline growth mechanism is the most active, the zone located between both points A, B is of particular interest. Crystallization will mainly occur during cooling after turning off the laser (the allotted time for crystallization is about 70 ns) on the one hand, heat gradients (upon cooling) are small in the thickness of the layer on the other hand. Both of these observations suggest that the crystalline microstructure is relatively uniform in the whole thickness of layer 26.

Accordingly, with the invention, it is notably possible to laser-anneal a not very absorptive layer in the wavelength range of interest or in the available one.

The example of SrTiO₃ was given, but the invention also applies to the modification of high K type materials, or materials with high dielectric constant K, for example larger than 3 or 3.9 and less than 100, like yttria (Y₂O₃), alumina (Al₂O₃), zirconia (ZrO₂), or hafnium oxide (HfO₂). Other materials with high K constant are for example PbZrTiO₃, BaTiO₃, PbTiO₃, BaSrTiO₃.

The invention also applies to the annealing of massive materials including a zone to be annealed and a neighboring zone or a zone in contact with the zone to be annealed, this neighboring zone absorbing and diffusing, towards the zone to be annealed, optical energy at the wavelength of a radiation source, notably of the laser type.

It also applies to the case of a layer including, as illustrated in FIG. 5, a first zone 30 which absorbs radiation 40 focused on point 42 and which will diffuse heat energy towards a second zone 32, close to the first or in contact with the latter. With this energy, it is possible to modify a characteristic of this second zone such as a physical or chemical characteristic as already indicated above. Both of these zones are for example made in a same material, zone 32 further having a particular doping level.

The anneal according to the invention may be used for crystallizing amorphous materials (increasing dielectric permittivities in high K type materials, for example). It may also provide diffusion of elements in materials (dopants in materials used in microelectronics, for example), or even local modification of the morphology of certain materials (in view of optical recordings of the CD or DVD type).

If the example of FIG. 1 is reexamined, the invention also applies to the case when zone 4 may exhibit absorption at the wavelength of the beam 10 but may have insufficient fastness to the light flux. There again, an alternative would be to distribute the light flux over both zones 2 and 4.

Finally, the example was given of a beam 10 emitted from a laser, but it may also be radiation emitted from another kind of source, notably from a coherent source.

Another example of applications relates to MIM capacitors, formed with a stack of substrate/metal/high K material/metal (the metal layers being used as electrical conductors in the capacitor). These metal layers may be used directly for heating of the high K material, according to one of the embodiments described above of the method of the invention.

1-20. (canceled)

21. A method for modifying, via a heat effect, at least one characteristic of a first zone of a first material, of high dielectric constant type, comprising:
directing light radiation towards a second zone in a second material, the second material being a metal, diffusion of heat energy from the second zone towards the first zone allowing a modification of the first zone via the heat effect.

22. The method according to claim 21, wherein the light radiation is of a laser beam.

23. The method according to claim 21, wherein the first zone is formed by a first layer of the first material and the second zone by a second layer of the second material.

24. The method according to claim 21, wherein the first and second zones are formed by a first portion and a second portion of a same layer, respectively.

25. The method according to claims 21, wherein the first and second zones are in a vicinity of a massive material.

26. The method according to claim 21, wherein the at least one characteristic of the first zone to be modified is a physical or a chemical characteristic.

27. The method according to claim 21, wherein the at least one characteristic to be modified of the first zone is an optical and/or a dielectric and/or a magnetic and/or a thermal and/or a crystalline and/or an amorphous characteristic and/or a chemical composition and/or a doping level and/or a morphology characteristic.

28. The method according to claim 21, wherein the metal is platinum.

29. The method according to claim 21, wherein the diffusion of heat energy provides a temperature rise in the second zone larger than 100° C. or 500° C. or 1,000° C.

30. The method according to claim 21, wherein the second zone exhibits a larger absorption of light radiation than the first zone.

31. The method according to claim 21, wherein the first material has a dielectric constant between 3 or 3.9 and 100.

32. The method according to claim 21, wherein the first material comprises SrTiO₃, or yttria (Y₂O₃), or alumina (Al₂O₃), or zirconia (ZrO₂), or hafnium oxide (HfO₂), or PbZrTiO₃, or BaTiO₃, or PbTiO₃, or BaSrTiO₃, or a mixture thereof.

33. The method according to claim 21, wherein the first material and the second material are part of an MIM capacitor.

34. A heterogeneous system of materials comprising:
a first zone in a first material, of high K dielectric constant type, having a physical and/or chemical characteristic capable of being thermally modified; and
a second zone in a second material, the second material being metal, to absorb at least one portion of radiation at one wavelength, and to transfer to the first zone at least one portion of the heat energy resulting from the absorption.

35. The system according to claim 34, wherein the first zone includes a first layer of the first material and the second zone includes a second layer of the second material.

36. The system according to claim 34, wherein the first and second zones include a first portion and a second portion of a same layer, respectively.

37. The system according to claim 34, wherein the first and second zones are in a vicinity of a massive material.

38. The system according to claim 34, wherein the first material has a dielectric constant between 3 or 3.9 and 100.

39. The system according to claim 34, wherein the first material comprises SrTiO₃, or yttria (Y₂O₃), or alumina (Al₂O₃), or zirconia (ZrO₂), or hafnium oxide (HfO₂), or PbZrTiO₃, or BaTiO₃, or PbTiO₃, or BaSrTiO₃, or a mixture thereof.

40. The system according to claim 34, wherein the first and second zones are part of an MIM capacitor.

41. A method for modifying, via a heat effect, at least one characteristic of a first zone of a first material, selected from the group of SrTiO₃, yttria (Y₂O₃), alumina (Al₂O₃), zirconia (ZrO₂), hafnium oxide (HfO₂), PbZrTiO₃, BaTiO₃, PbTiO₃, BaSrTiO₃, or a mixture thereof, comprising:
directing a laser beam towards a second zone in a second material, the second material being a metal, diffusion of heat energy from the second zone towards the first zone allowing a modification of the first zone via the heat effect.

42. The method according to claim 41, wherein the first zone is formed by a first layer of the first material and the second zone by a second layer of the second material.

43. The method according to claim 41, wherein the first and second zones are formed by a first portion and a second portion of a same layer, respectively.

44. The method according to claim 41, wherein the first and second zones are in a vicinity of a massive material.

45. The method according to claim 41, wherein the at least one characteristic of the first zone to be modified is a physical or a chemical characteristic.

46. The method according to claim 41, wherein the at least one characteristic to be modified of the first zone is an optical and/or a dielectric and/or a magnetic and/or a thermal and/or a crystalline and/or an amorphous characteristic and/or a chemical composition and/or a doping level and/or a morphology characteristic.

47. The method according to claim 41, wherein the metal is platinum.

48. The method according to claim 41, wherein the diffusion of heat energy provides a temperature rise in the second zone larger than 100° C. or 500° C. or 1,000° C.

49. The method according to claim 48, wherein the second zone exhibits larger absorption of light radiation than the first zone.

50. A heterogeneous system of materials comprising:
a first zone in a first material, selected from the group of SrTiO₃, yttria (Y₂O₃), alumina (Al₂O₃), zirconia (ZrO₂), hafnium oxide (HfO₂), PbZrTiO₃, BaTiO₃, PbTiO₃, BaSrTiO₃, or a mixture thereof, having a physical and/or chemical characteristic capable of being thermally modified; and
a second zone in a second material, the second material being metal, to absorb at least one portion of radiation at one wavelength, and to transfer to the first zone at least one portion of the heat energy resulting from the absorption.

51. The system according to claim 50, wherein the first zone includes a first layer of the first material and the second zone includes a second layer of the second material.

52. The system according to claim 50, wherein the first and second zones include a first portion and a second portion of a same layer, respectively.

53. The system according to claim 50, wherein the first and second zones are in a vicinity of a massive material.
